(19) United States
(12) Patent Application Publication
(10) Pub. No.: US 2026/0099278 A1
(43) Pub. Date: Apr. 9, 2026

(54) SYSTEM, IMAGE FORMING APPARATUS, METHOD OF IMAGE FORMING APPARATUS, AND STORAGE MEDIUM

(71) Applicant: CANON KABUSHIKI KAISHA, Tokyo (JP)

(72) Inventor: HIROYUKI OKAMOTO, Kanagawa (JP)

(21) Appl. No.: 19/347,146

(22) Filed: Oct. 1, 2025

(30) Foreign Application Priority Data
Oct. 8, 2024 (JP) 2024-176788

(51) Int. Cl. G06F 3/12; G06K 15/00

(52) U.S. Cl. CPC G06F 3/1204; G06F 3/1253; G06F 3/1288; G06K 15/002; G06K 15/4065

(57) ABSTRACT

A system includes an image forming apparatus, a server, and a client terminal, the image forming apparatus transmitting, to the server, information indicating a number of sheets used for a printing operation by the image forming apparatus, the server receiving an instruction to increase the number of sheets permitted to be used by the image forming apparatus, the server managing the number of sheets permitted to be used by the image forming apparatus based on the instruction, wherein, in a case where the number of sheets permitted to be used by the image forming apparatus is less than a number of sheets required to execute a printing operation, the server transmits information for issuing a push notification on the client terminal to a different server, and wherein, if the push notification is selected by a user on the client terminal, a screen is displayed.

### BACKGROUND

### Field of the Technology

The present disclosure relates to a technique for increasing the permitted number of sheets to be printed in a printer.

### Description of the Related Art

In recent years, many devices have connected to the internet, and “Internet of Things (IoT)” of transmitting the control of various devices, and operational data of the devices to a cloud, and using these on the cloud has started to become generally common. In a similar manner, printers have become connected to a cloud service.

The business structure of printers has changed. For example, a service that can manage the data of the number of sheets to be printed in a printer by a cloud service and enables printing within the number of sheets to be printed purchased in advance has emerged.

In such a service, if a user uses up the purchased sheets corresponding to the number of sheets to be printed by printing, the user becomes unable to perform printing and copying. For this reason, in a case where the remaining number of purchased sheets to be printed is getting low, or in a case where the remaining number of purchased sheets to be printed becomes zero, the user needs to perform additional purchase processing. Japanese Patent Laid-Open No. 2022-156401 describes displaying, in a case where the remaining number of sheets to be printed becomes less than a threshold value, a message prompting the user to purchase additional sheets on an application or a web site provided by a print service.

The user in Japanese Patent Laid-Open No. 2022-156401 is seen to need to, by themselves, find out and display a target application or web site on a client terminal for purchase for addition of the number of sheets to be printed, which is bothersome.

### SUMMARY

In view of the foregoing, the present disclosure is directed to enabling the user to browse a screen for the user to easily perform purchase for addition of the number of sheets to be printed.

According to an aspect of the present disclosure, a system includes an image forming apparatus, a server configured to manage a number of sheets permitted to be used by the image forming apparatus for printing operations, and a client terminal, wherein the image forming apparatus transmits, to the server, information indicating a number of sheets used for a printing operation by the image forming apparatus, wherein the server receives an instruction, from a user via a screen displayed on the client terminal. to increase the number of sheets permitted to be used by the image forming apparatus, wherein, based on the received instruction, the server manages the number of sheets permitted to be used by the image forming apparatus, wherein, in a case where the number of sheets permitted to be used by the image forming apparatus is less than a number of sheets required to execute a printing operation, the server transmits information for issuing a push notification on the client terminal to a different server, and wherein, if the push notification is selected by a user on the client terminal, the screen is displayed.

Features of the present disclosure will become apparent from the following description of embodiments with reference to the attached drawings. The following description of embodiments is described by way of example.

### BRIEF DESCRIPTION OF THE DRAWINGS

FIG. 1 illustrates an overall configuration of a system according to a first embodiment.

FIGS. 2A and 2B are hardware configuration diagrams of apparatuses included in the system according to the first embodiment.

FIG. 3 is a software configuration diagram of apparatuses included in the system according to the first embodiment.

FIGS. 4A to 4D each illustrate an example of a screen of a client terminal according to the first embodiment.

FIGS. 5A and 5B illustrate an overall sequence of the system according to the first embodiment.

FIG. 6 is a flowchart of a print service according to the first embodiment.

FIG. 7 illustrates an overall sequence of the system according to a second embodiment.

FIGS. 8A and 8B each illustrate an example of an operation panel of an image forming apparatus according to a third embodiment.

FIGS. 9A and 9B illustrate an overall sequence of a system according to the third embodiment.

FIGS. 10A and 10B each illustrate an example of an operation panel of an image forming apparatus according to a fourth embodiment.

FIG. 11 illustrates an overall sequence of a system according to the fourth embodiment.

### DESCRIPTION OF THE EMBODIMENTS

Hereinafter, the mode for carrying out the present disclosure will be described with reference to the attached drawings.

### First Embodiment

An embodiment of the present disclosure will be described.

The terms in the present embodiment will now be described. In the present embodiment, the number of sheets on which printing is permitted in an image forming apparatus (printer) will be described as “the number of printable sheets”.

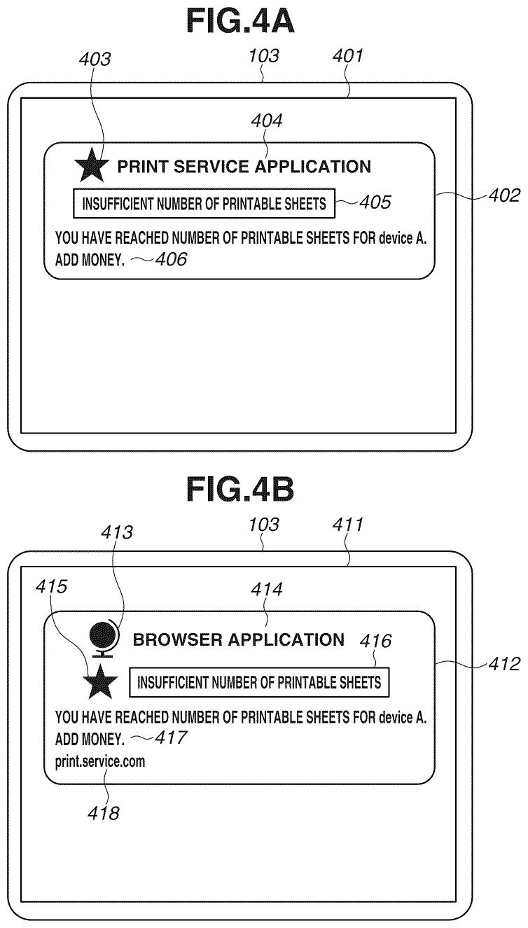

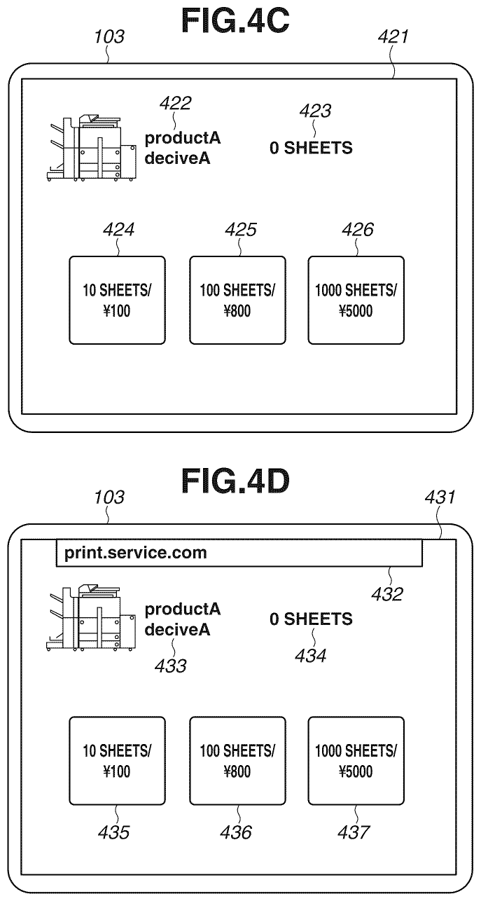

The number of sheets on which printing is permitted in an image forming apparatus is increased by the user performing payment processing of a money amount corresponding to the number of sheet, via a predetermined screen illustrated in FIG. 4C, 4D, or the like, which will be described below. Then, if printing is performed in an image forming apparatus, the number of sheets on which printing is permitted decreases by the number of printed sheets. If the number of sheets on which printing is permitted becomes zero, or if the number of sheets on which printing is permitted becomes less than the number of sheets to be printed, printing is restricted in the image forming apparatus.

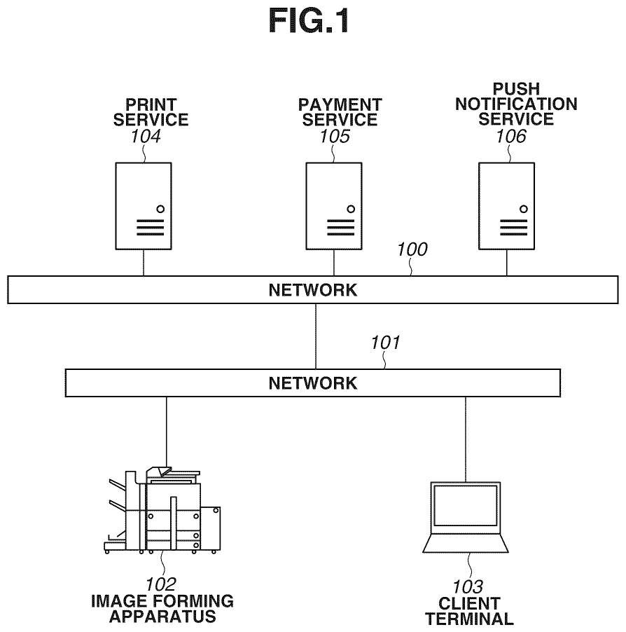

FIG. 1 is a diagram illustrating an overall configuration of a system according to an embodiment of the present disclosure.

In FIG. 1, networks 100 and 101 are communication networks implemented by, for example, a local area network (LAN) such as the internet, a wide area network (WAN), a telephone line, a dedicated digital line, an asynchronous transfer mode (ATM), a frame relay line, a cable television line, a wireless line for data broadcasting, or the like. The networks 100 and 101 are only required to be enabled to perform data transmission and reception. In the present disclosure, the network 100 is the internet, while the network 101 is a local network or the like.

An image forming apparatus 102 and a client terminal 103 can access the network (internet) 100 via the network (local network) 101, and access a print service 104, a payment service 105, and a push notification service 106. That is, the apparatuses 102 to 106 can communicate with each other.

The image forming apparatus 102 is a multifunction peripheral or a printer including a copy function, a scanner function, a FAX function, and the like in addition to a print function. The image forming apparatus 102 stores the number of printable sheets, where the number of printable sheets increases based on a number-of-printable-sheets increase instruction from the print service 104, and decreases by performing printing, copy, or FAX printing.

The client terminal 103 is a data processing apparatus for using a cloud service, such as a personal computer or a mobile terminal. The client terminal 103 is a computer used by a user of the image forming apparatus 102, and transmits a charge instruction and the like to the print service 104.

The network 101 is a LAN to which the image forming apparatus 102 and the client terminal 103 are connected. The image forming apparatus 102, the client terminal 103, and various services 104, 105, and 106 communicate with each other via the LAN.

The print service 104 is a server for providing a print service, performs the management of users and devices that use a print service, and provides functions related to printing.

The print service 104 stores the number of printable sheets charged for each device.

In the present embodiment, the user issuing a charge instruction to the print service 104 via the client terminal 103 results in the print service 104 performing payment processing and issuing a number-of-printable-sheets increase instruction to the image forming apparatus 102.

The payment service 105 is a server for providing a payment service, and performs payment processing for purchase when the user adds money. As the payment service 105, a third-party service provided by a payment business operator such as a credit-card company or a paying agent company may be used, or a print service provider may prepare the payment service 105.

The push notification service 106 is a server for making a push notification, where the push notification is made to, for example, the client terminal 103. Third party services, such as Apple Push Notification Service (APNs) and Firebase Cloud Messaging (FCM) may be used, or a print service provider may prepare the push notification service 106.

The print service 104 can make a push notification to the client terminal 103 by issuing a push notification instruction to the push notification service 106.

The print service 104, the payment service 105, and the push notification service 106 are publicly available on the internet as a cloud service. A function of each service may be implemented by a single server, a single virtual server, or a plurality of servers, or a plurality of virtual servers. A plurality of virtual servers may be executed on a single server. As described above, services provided by a third party may be used as the payment service 105 and the push notification service 106.

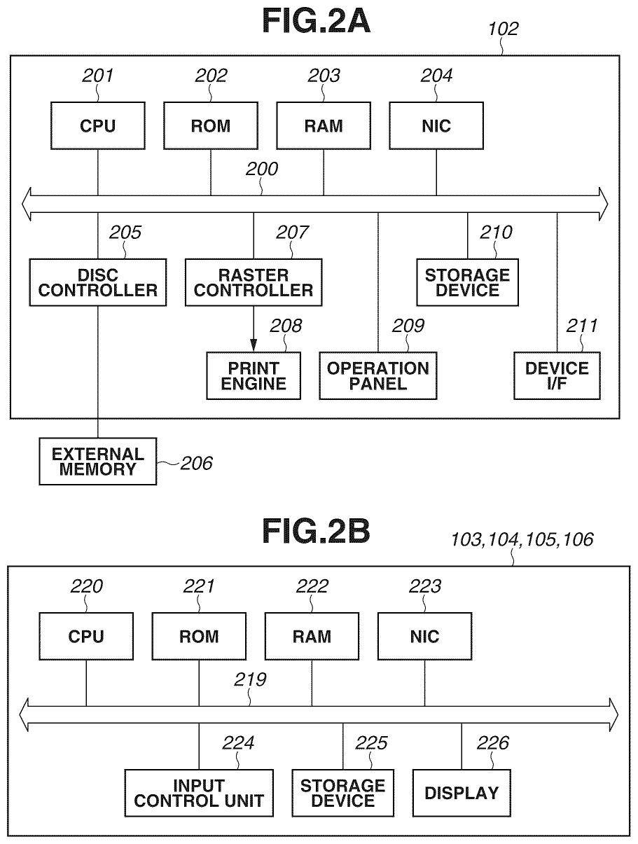

FIG. 2A is a hardware configuration diagram of the image forming apparatus 102 according to an embodiment of the present disclosure. Each hardware component is connected to a system bus 200.

A central processing unit (CPU) 201 is a CPU that controls the apparatus and controls access to various devices connected to the system bus 200. The control is based on a control program or the like that is stored in a read-only memory (ROM) 202, or a control program, resource data (resource information), or the like stored in an external memory 206 connected via a disc controller 205. A random access memory (RAM) 203 is a RAM functioning as a main memory, a work area, and the like of the CPU 201, and is configured to expand memory capacity by an optional RAM connected to an expansion port (not illustrated). A storage device 210 is an external storage unit functioning as a large-capacity memory, and stores programs of units 301 to 306 according to the present disclosure, which are described below. An operation panel 209 includes an operation unit and a display unit for receiving an operation instruction from a user, and performs the setting of an operation mode or the like of the image forming apparatus 102, the display of an operational status of the image forming apparatus 102, and an operation such as copy designation. The operation unit may be a physical button, a touch panel operable by touching a liquid crystal panel, or a combination of these. The display unit may be a liquid crystal panel, a lamp such as a light-emitting diode (LED), or a combination of these. Data is exchanged with an external apparatus via a network interface card (NIC) 204. A known printing technique is used as a print engine 208, and examples of desirable implementation systems include an electrophotographic method (laser beam method), an inkjet method, a sublimation (heat transfer) method, and the like. A raster controller 207 is a controller that converts print data in a page-description language (PDL) or a portable document format (PDF) language, into image data. A device interface (I/F) 211 is a connection I/F with an external device connectable via a universal serial bus (USB) or the like.

FIG. 2B is a hardware configuration diagram of the client terminal 103, the print service 104, the payment service 105, or the push notification service 106 according to an embodiment of the present disclosure. These apparatuses are considered information processing apparatuses for purposes of the following discussion.

Unless otherwise stated, as long as functions of the present disclosure can be executed, the present disclosure can be applied to a single device and a system including a plurality of devices. Unless otherwise stated, as long as functions of the present disclosure can be executed, the present disclosure can be applied to a system in which connection is established via a network such as a LAN or a WAN, and processing is performed.

CPU 220 is a control device of an information processing apparatus, and performs control of temporarily storing information, files, and the like necessary for program execution, into a RAM 222 by executing an application program, an operating system, or the like that is stored in a storage device 225. The ROM 221 serves as a storage unit, and stores a program such as a basic input-output (I/O) program and various types of data. The RAM 222 serves as a temporary storage unit, and functions as a main memory, a work area, and the like of the CPU 220. Data is exchanged with an external apparatus via an NIC 223. An input control unit 224 enables the information processing apparatus to exchange data with an external apparatus. The storage device 225 is an external storage unit functioning as a large-capacity memory, and stores an application program, an OS, or the like. A display 226 is a display unit that displays program results, information necessary for input operations, and the like. The display 226 may be a device such as a touch panel that includes a function of receiving an operation instruction from the user. As described above, services provided by a third party may be used as the payment service 105 and the push notification service 106, and a hardware configuration in this case follows a configuration of the services provided by the third party.

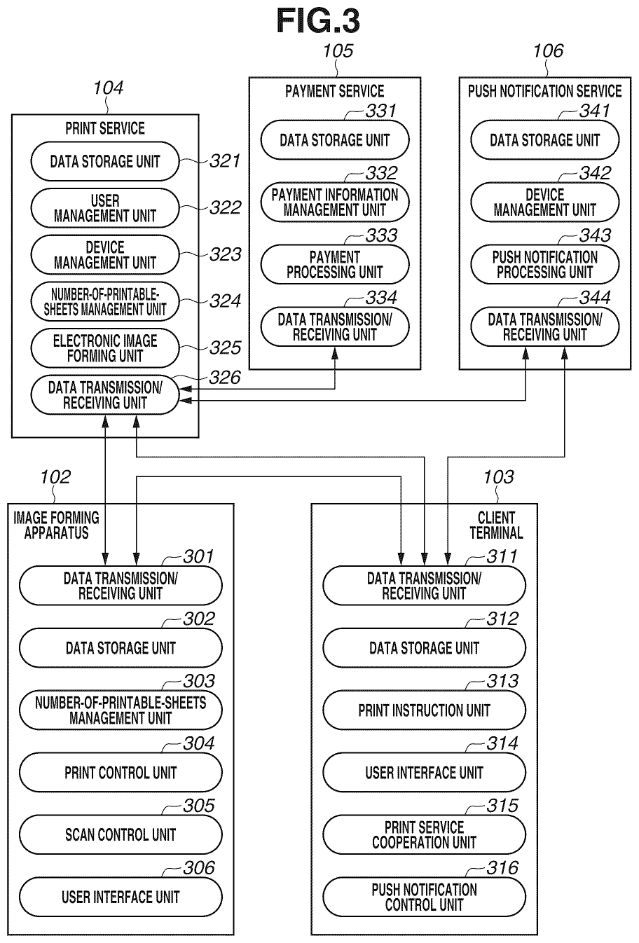

FIG. 3 illustrates software configurations of functions of the present disclosure associated with the image forming apparatus 102, the client terminal 103, the print service 104, the payment service 105, and the push notification service 106 according to the present embodiment. Software modules are stored in the storage devices 210 and 225 illustrated in FIGS. 2A and 2B, and as described above, and loaded into the RAMs 203 and 222 and executed by the CPUs 201 and 220.

The image forming apparatus 102 includes a data transmission/receiving unit 301, a data storage unit 302, a number-of-printable-sheets management unit 303, a print control unit 304, a scan control unit 305, and a user interface unit 306. The data transmission/receiving unit 301 performs the transmission of a push notification instruction of the image forming apparatus 102, a print result, and the like to the print service 104, and data reception of a number-of-printable-sheets increase instruction and a print instruction from the print service 104. The data storage unit 302 stores data entered by the user, device information, the number of printable sheets, and the like. The number-of-printable-sheets management unit 303 performs the management of the number of printable sheets such as data storing into the data storage unit 302 of the number of printable sheets by which a device can execute printing, and the update of the stored number of printable sheets. Table 1 provided below is an example of the number of printable sheets to be to be managed by the number-of-printable-sheets management unit 303.

TABLE 1
Number-of-Printable-Sheets Management Table (Image Forming Apparatus 102)

| Number-of-Printable-Sheets | Notification Threshold Value | Update Date and Time |
|---|---|---|
| 1000 | 0 | 2024 Dec. 30 12:00 |

A number-of-printable-sheets column indicates the number of printable sheets by which the image forming apparatus 102 can execute printing. The number of printable sheets is increased based on a number-of-printable-sheets increase instruction from the print service 104 and reduced if a device performs printing, copy, or FAX printing. A notification threshold value column indicates a threshold value of the number of printable sheets at which a push notification is to be made. If the number of printable sheets becomes less than or equal to the notification threshold value, a push notification instruction is transmitted to the print service 104. The notification threshold value may be made changeable by an administrator or a user of the print service, or may be made unchangeable. An update date and time column indicates date and time on which the number of printable sheets was last updated. The update date and time column indicates a time at which an increase instruction from the print service 104 has been received, or printing, copy, or FAX printing has been performed. The image forming apparatus 102 and the print service 104 perform the transmission and reception of information regarding the number of printable sheets such that the number of printable sheets managed by the number-of-printable-sheets management unit 303 becomes the same value as the number of printable sheets managed by a number-of-printable-sheets management unit 324, as described below. The user interface unit 306 receives an operation made by the user, and performs printing by the print control unit 304, scanning by the scan control unit 305, and the like in accordance with the operation.

The client terminal 103 includes a data transmission/receiving unit 311, a data storage unit 312, a print instruction unit 313, a user interface unit 314, a print service cooperation unit 315, and a push notification control unit 316. The data transmission/receiving unit 311 performs the data transmission of an information registration instruction, a print instruction, a charge instruction, and the like to the print service 104, and the data reception of device information, the number of printable sheets, and the like from the print service 104. The data storage unit 312 stores data regarding the image forming apparatus 102, data regarding the print service 104, and the like. The print instruction unit 313 issues a print instruction via the print service 104 or directly to the image forming apparatus 102. The print instruction unit 313 may be a client application provided by the print service 104, may be a web site provided by the print service 104, or may be a printer driver. The user interface unit 314 performs processing related to screen display of the client terminal 103 and receipt of an operation from the user. Based on the operation, the client terminal 103 issues an instruction to the image forming apparatus 102, an instruction to the print service 104, and the like. The print service cooperation unit 315 performs data registration instruction and charge instruction to the print service 104, and the display of data such as user interface (UI) data received from the print service 104. The print service cooperation unit 315 may be a browser application, or may be a client application provided by the print service 104.

The push notification control unit 316 performs the registration into the push notification service 106, of the client terminal 103 and a browser application that is to be used in the client terminal 103, which is necessary for making a push notification. By transmitting a notification ID issued by the push notification service 106 at the time of registration into the push notification service 106, to the print service 104, the print service 104 can designate a push notification destination. The notification ID is sometimes called a delivery ID, a device token, or the like. When a push notification is received, processing such as the display of the push notification on the user interface unit 314 is performed. The push notification control unit 316 may use a function of an operating system (OS). In the case of issuing a web push notification as a push notification, a function of a service worker or the like that is supported by a browser application may be used. As described above, a function provided by a third party may be used as the push notification control unit 316, or a print service provider may prepare the push notification control unit 316.

The print service 104 includes a data storage unit 321, a user management unit 322, a device management unit 323, the number-of-printable-sheets management unit 324, an electronic image forming unit 325, and a data transmission/receiving unit 326.

The data storage unit 321 stores data on users registered in a print service, data on device, the number of printable sheets, and the like.

The user management unit 322 performs user management such as data storing into the data storage unit 321 of users using the print service, and the update and deletion of stored user data. Table 2 provided below illustrates an example of user data to be managed by the user management unit 322.

TABLE 2
User Management Table

| User ID | Password | Login state | Login Expiration Date | Notification ID |
|---|---|---|---|---|
| user A | ********** | on | 2024 Dec. 31 0:00 | 1111 |
| user B | ********** | on | 2024 Dec. 31 0:00 | 2222 |
| user C | ********** | off | | 3333, 4444 |
| user D | ********** | off | | |

A user ID column indicates an ID for uniquely identifying a user. A password column indicates a password for basic authentication of a user ID that is to be used at the time of login. The user management unit 322 checks a combination of a user ID and a password included in a login request from the client terminal 103, against Table 1. If these match, the user management unit 322 returns a login result indicating a success to each client terminal. In the present embodiment, basic authentication has been described as an example of an authentication method, but another authentication method may be used. A login state column indicates a login state of each user, “on” indicates a login state, and “off” indicates a logout state. A login expiration date column indicates an expiration date of an authentication state of a login user. A notification ID column indicates an identifier of a client terminal owned by a user or a browser application used on a client terminal, and is used to designate a push notification destination when making a push notification. A notification ID column indicates an ID issued by the push notification service 106 and issued from the push notification service 106 in a case where the user permits a push notification. In a case where the user uses a plurality of client terminals or browser applications, a plurality of notification IDs are managed. In a case where the user does not permit a push notification, the notification ID column is left blank.

The device management unit 323 performs device management such as data storing into the data storage unit 321 of a device that uses the print service, and the update and deletion of stored device data. Table 3 provided below illustrates an example of device data to be managed by the device management unit 323.

TABLE 3
Device Management Table

| Device ID | Model | User ID |
|---|---|---|
| device A | product A | user A |
| device B | product B | user B, user C |
| device C | product | user D |

A device ID column indicates an ID for uniquely identifying a device. A model column indicates a model name of a device. A user ID column indicates a user ID of a user who uses a device, is a user managed in the user management table (Table 2), and is a user to which a push notification related to the device is to be made. In a case where a plurality of users uses one device, a plurality of user IDs are managed. A push notification may be made to all users on the user ID column, a push notification may be made only to a representative user, or a notification destination user ID may be separately managed and a push notification may be made to the user.

The number-of-printable-sheets management unit 324 performs the management of the number of printable sheets such as data storing into the data storage unit 321 of the number of printable sheets by which a device using the print service can execute printing, and the update of the stored number of printable sheets. Table 4 provided below illustrates an example of the number of printable sheets of each device that is to be managed by the number-of-printable-sheets management unit 324.

TABLE 4
Number-of-Printable-Sheets Management Table (Print Service 104)

| | | Notification | |
|---|---|---|---|
| Device | Number-of- | Threshold | Update Date and |
| ID | Printable-Sheets | Value | Time |
| device A | 1000 | 0 | 2024 Dec. 30 12:00 |
| device B | 2000 | 0 | 2024 Dec. 30 13:00 |
| device C | 3000 | 20 | 2024 Dec. 20 10:00 |

A device ID column indicates an ID for uniquely identifying a device managed in the device management table (Table 3). A number of printable sheets column indicates the number of printable sheets by which each device can execute printing. The number of printable sheets is increased based on a charge instruction from the client terminal 103 and reduced if a corresponding device performs printing, copy, or FAX printing. A notification threshold value column indicates a threshold value of the number of printable sheets at which a push notification is to be made. If the number of printable sheets becomes less than or equal to the notification threshold value, a push notification instruction is issued. The notification threshold value may be made changeable by an administrator or a user of the print service, or may be made unchangeable. An update date and time column indicates date and time on which the number of printable sheets was last updated. The update date and time column indicates a time at which a charge instruction from the client terminal 103 has been received, or information regarding printing, copy, FAX printing, or the number of printable sheets has been received from the image forming apparatus 102. The print service 104 and the image forming apparatus 102 perform the transmission and reception of information regarding the number of printable sheets such that the number of printable sheets managed by the number-of-printable-sheets management unit 324 becomes the same value as the number of printable sheets managed by the number-of-printable-sheets management unit 303.

Table 5 provided below illustrates an example of a fee of each number of printable sheets managed by the number-of-printable-sheets management unit 324. Hereinafter, a combination of the number of printable sheets and a fee will be referred to as a charge plan.

TABLE 5
Charge Plan Management Table

| Number-of-Printable-Sheets | Fee (JPY) |
|---|---|
| 10 | 100 |
| 100 | 800 |
| 1000 | 5000 |

A number of printable sheets column indicates the number of printable sheets to be increased. A fee column indicates a fee for purchasing the sheets corresponding to the number of printable sheets. While uses JPY (currency code for Japanese Yen) is used as an example, any currency type may be used, or a column may be increased for each unit and management may be performed. The print service 104 presents charge plans in the charge plan management table (Table 5) to the user, and the user selects a charge plan from among the presented charge plans, and adds money.

In the case of issuing a print instruction to image forming apparatus 102 from the print service 104, the electronic image forming unit 325 generates electronic data of a print job to be transmitted as a print instruction. By transmitting the electronic data to the image forming apparatus 102, the image forming apparatus 102 executes printing. The data transmission/receiving unit 326 performs data transmission and reception with the image forming apparatus 102, the client terminal 103, the payment service 105, and the push notification service 106. The data transmission/receiving unit 326 performs the data transmission of a print instruction, a number-of-printable-sheets increase instruction, and the like to the image forming apparatus 102, and the data reception of execution data of printing, copy, or FAX printing, the number of printable sheets, and the like from the image forming apparatus 102. The data transmission/receiving unit 326 performs the data reception of an information registration instruction, a print instruction, a charge instruction, and the like from the client terminal 103, and the transmission of a charge plan and data such as the number of printable sheets to the client terminal 103. The data transmission/receiving unit 326 performs data transmission related to payment to the payment service 105, and data reception related to a payment result from the payment service 105. The data transmission/receiving unit 326 performs the data transmission of a push notification instruction to the push notification service 106, and data reception related to a push notification instruction result.

The payment service 105 includes a data storage unit 331, a payment information management unit 332, a payment processing unit 333, and a data transmission/receiving unit 334. The data storage unit 331 stores data related to payment such as data on a user who uses a payment service, a print service operator, or a financial organization. The payment information management unit 332 performs data storing into the data storage unit 331 of data related to payment, update and deletion of stored data, and the like. The payment processing unit 333 performs processing related to payment. In a case where payment information of the user and a payment request of a fee that is based on a charge plan are received from the print service 104, the payment processing unit 333 performs the payment to a print service operator and charging processing to the user based on the payment request. The data transmission/receiving unit 334 performs the transmission and reception of data related to payment. The data transmission/receiving unit 334 performs the data reception of payment information, a payment request, and the like from the print service 104, and the transmission of a payment result to the print service 104. By the print service 104 redirecting access from the client terminal 103, to the payment service 105, the client terminal 103 and the payment service 105 may directly perform the transmission and reception of data related to payment. The configurations and processing of the units 331 to 334 are mere examples, and in a case where a third-party service provided by a payment business operator such as a credit-card company or a paying agent company is used as the payment service 105, the configuration suitable for the third-party service are employed and processing suitable for the third-party service is performed.

The push notification service 106 includes a data storage unit 341, a device management unit 342, a push notification processing unit 343, and a data transmission/receiving unit 344. The data storage unit 341 stores data related to a push notification, such as an identifier of a device to which a push notification is issued. The device management unit 342 performs data storing into the data storage unit 331 of data related to a push notification, the update and deletion of stored data, and the like. The push notification processing unit 343 performs processing related to a push notification. In a case where a device registration request is received from the client terminal 103, device registration of the client terminal 103 and issuance of a notification ID are performed. The notification ID is sometimes called a delivery ID, a device token, or the like. In addition, in a case where a push notification instruction is received from the print service 104, based on a notification ID and a notification message included in the push notification instruction, a push notification is made to a device with the notification ID. The data transmission/receiving unit 344 performs the transmission and reception of data related to a push notification. The data transmission/receiving unit 344 performs the data reception of a device registration request from the client terminal 103, a push notification instruction from the print service 104, and the like, and the data transmission of a notification ID, a push notification, and the like to the client terminal 103. The configurations and processing of the units 341 to 344 are mere examples, and in a case where a third-party service provided by a third party is used as the push notification service 106, the configuration suitable for the third-party service are employed and processing suitable for the third-party service is performed.

A method of making a push notification in a case where the number of printable sheets becomes less than a threshold value in an information processing apparatus and a program, which is an aspect of the present disclosure, will be described with reference to FIGS. 4A to 4D, 5, and 6.

FIGS. 4A and 4B illustrate UIs to be displayed on the display 226 of the client terminal 103, and UIs on which a push notification received by the client terminal 103 from the print service 104 via the push notification service 106 is displayed. FIG. 4A illustrates a UI on which a push notification of a client application provided by a print service is displayed. FIG. 4B illustrates a UI on which a web push notification of a web site provided by a print service is displayed via a browser application. FIGS. 4C and 4D illustrate UIs to be displayed on the display 226 of the client terminal 103, and UIs for adding money for a device of a client application or a web site provided by the print service. FIG. 4C illustrates a UI for adding money for a device of a client application provided by the print service. FIG. 4D illustrates a UI of a web page for adding money for a device of a web site provided by the print service via a browser application. The web site may be provided by the print service 104, or an embedded web server (EWS) may be included in the image forming apparatus 102 and the EWS may provide the web site.

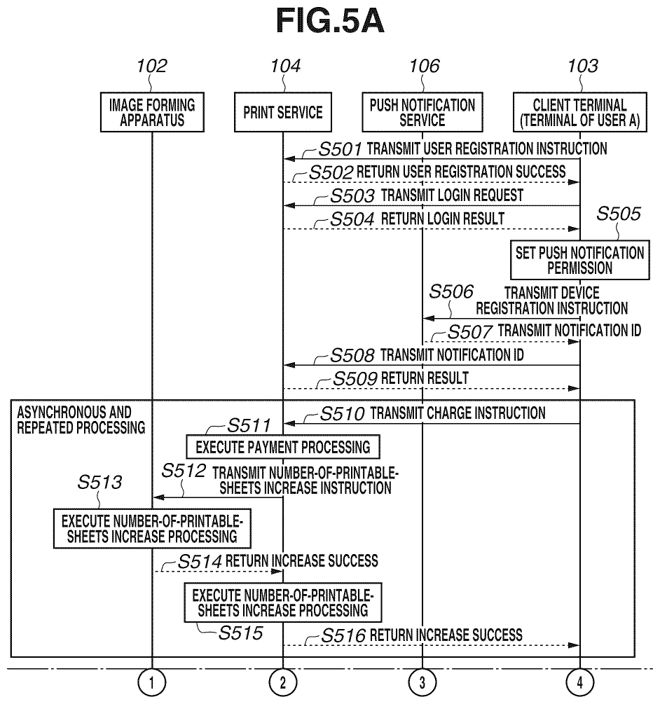

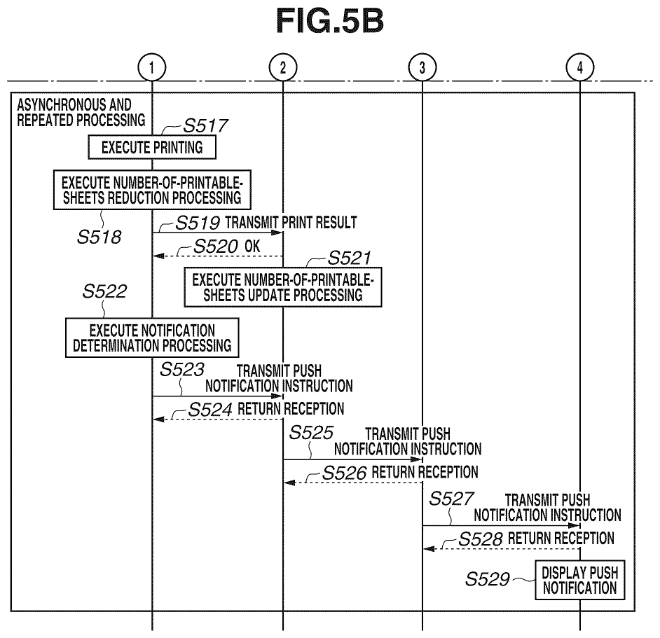

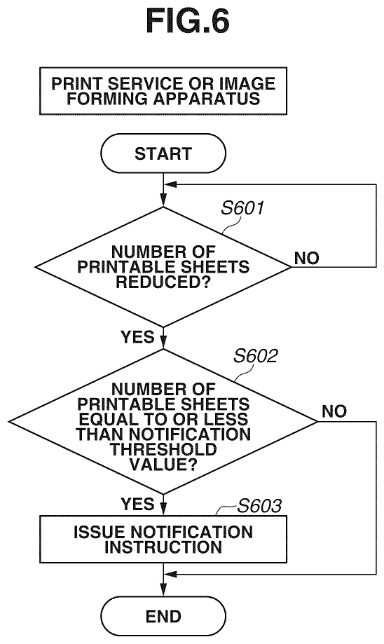

FIGS. 5A and 5B are a diagram illustrating an example of a sequence from the user's start of use of the print service up to receipt of a push notification. FIG. 6 is a flowchart illustrating processing in the sequence in FIGS. 5A and 5B.

In the present embodiment, a user who operates the client terminal 103 is assumed to be a user described as a user A on the user ID column in Tables 2 and 3 described above. The user A is a user who uses the image forming apparatus 102, and the image forming apparatus 102 is assumed to be a device described as a device A on the device ID column in Tables 3 and 4 described above.

FIG. 4A will now be described.

A display 401 in FIG. 4A corresponds to the display 226 of the client terminal 103 used by the user A, and displays an example of a UI on which a push notification of a client application provided by the print service is displayed. A popup window 402 is a popup window of a push notification. An icon 403 is an icon of the client application, and a name 404 is a name of the client application, which indicate an application from which a push notification is made. A title 405 is a title of a push notification, and a message 406 is a message of a push notification, which indicate the description of the push notification. The message 406 displays a message indicating that the number of printable sheets becomes zero, e.g., “You have reached the number of printable sheets for the device A. Add money.”. This is merely an example, and a message indicating that the number of printable sheets is getting low, or the like may be displayed. By setting a deep link to a UI for adding money for the device A in FIG. 4C, in the push notification, the selection of the push notification 402 can cause direct transition to the UI in FIG. 4C.

FIG. 4B will now be described.

A display 411 in FIG. 4B corresponds to the display 226 of the client terminal 103 used by the user A, and displays an example of a UI on which a web push notification of a web site provided by the print service 104 is displayed via a browser application. A popup window 412 is a popup window of a web push notification. An icon 413 is an icon of the browser application, and a name 414 is a name of the browser application. An icon 415 is an icon of a web site provided by the print service 104, and a domain 418 is a domain of the web site. Items 413, 414, 415, and 418 indicate from which web site a web push notification has been made via which browser application. A title 416 is a title of a push notification, and a message 417 is a message of a push notification, which indicate the description of the push notification. The message 417 displays a message indicating that the number of printable sheets becomes zero, e.g., “You have reached the number of printable sheets for the device A. Add money.”. This is merely an example, and a message indicating that the number of printable sheets is getting low or the like may be displayed. By setting a link to a web page for adding money for the device A in FIG. 4D, in the push notification, the selection of the push notification 412 can cause direct transition to the UI in FIG. 4D.

FIG. 4C will now be described.

A display 421 in FIG. 4C corresponds to the display 226 of the client terminal 103 used by the user A, and displays an example of a UI for adding money for the device A of a client application provided by the print service 104. In device information 422, a model name and a device ID managed in the device management table (Table 3) are displayed. A number of printable sheets 423 displays the number of printable sheets. In charge plans 424, 425, and 426, charge plans managed in the charge plan management table (Table 5) are displayed. By the user selecting a charge plan from the charge plans 424, 425, and 426, payment processing and increase processing of the number of printable sheets are performed. The charge plans 424, 425, and 426 indicate purchase buttons of loading the sheets corresponding to the number of sheets to be printed. These are a plurality of choices in which different numbers of sheets are displayed, and are the choices for increasing the sheets corresponding to the number of sheets by which printing is executable in an image forming apparatus. In such a choice (button), the number of sheets to be printed is displayed. An amount of money to be paid by the user to load the sheets corresponding to the number of sheets to be printed is also displayed. A money amount per sheet that is calculated based on the money amount and the number of sheets to be printed may be displayed. A paper type may also be displayed. If any of the plurality of choices is pressed, it is possible to proceed to a purchase procedure screen (not illustrated) of loading the sheets corresponding to the number of sheets to be printed described in the button. The number of purchase buttons of loading the sheets corresponding to the number of sheets to be printed that are to be displayed may be greater or less than three.

FIG. 4D will now be described.

A display 431 in FIG. 4D corresponds to the display 226 of the client terminal 103 used by the user A, and displays an example of a UI for adding money for the device A of a web site provided by the print service 104. A uniform resource locator (URL) 431 is a URL of the web site. In device information 433, a model name and a device ID managed in the device management table (Table 3) are displayed. A number of printable sheets 434 displays the number of printable sheets. In charge plans 435, 436, and 437, charge plans managed in the charge plan management table (Table 5) are displayed. By the user selecting a charge plan from the charge plans 435, 436, and 437, payment processing and increase processing of the number of printable sheets are performed. The detailed description of the charge plans 435, 436, and 437 is similar to that of the charge plans 424, 425, and 426, and thus their description will be omitted herein.

The overall processing sequence will now be described with reference to FIGS. 5A and 5B.

In step S501, the user A performs user registration into the print service 104. In step S501, the data transmission/receiving unit 311 of the client terminal 103 of the user A transmits, to the data transmission/receiving unit 326, a user registration instruction including information for user registration such as a user ID and a password entered via the user interface unit 314. In step S502, the user management unit 322 stores the received user ID and password into the user management table (Table 2) stored in the data storage unit 321, and returns a result indicating a user registration success.

In step S503, the data transmission/receiving unit 311 of the client terminal 103 of the user A transmits the user ID and the password entered via the user interface unit 314 to the data transmission/receiving unit 326. In step S504, the user management unit 322 refers to the user management table (Table 2) stored in the data storage unit 321, confirms that the user ID and the password match those of the user A. If there is a match, the user management unit 322 returns a login result indicating a login success.

In step S505, the user A makes a permission setting of a push notification of the client application. In step S506, the push notification control unit 316 transmits device information and a device registration instruction of the client terminal 103 to the push notification service 106 via the data transmission/receiving unit 311. In the case of making a permission setting of a push notification of a web site provided by the print service 104, via a browser application, information regarding the browser application and a device registration instruction are transmitted to the push notification service 106.

In step S507, the device management unit 342 issues a notification ID of the client terminal 103 or the browser application, and stores the notification ID and device information about the client terminal 103 or the browser application into the data storage unit 341. In step S507, the data transmission/receiving unit 344 of the push notification service 106 transmits the notification ID to the data transmission/receiving unit 311 of the client terminal 103. In step S508, the push notification control unit 316 transmits the notification ID to the data transmission/receiving unit 326. In step S509, the device management unit 323 stores the received notification ID into the user management table (Table 2) stored in the data storage unit 321, and returns a result indicating a notification ID storing success.

Next, n steps S510 to S516, processing steps related to charge processing are executed, and repeatedly executed asynchronously with steps S517 to S529 described below.

In step S510, if the user A inputs a charge instruction to the user interface unit 314, the print service cooperation unit 315 transmits the charge instruction to the data transmission/receiving unit 326 via the data transmission/receiving unit 311. The charge instruction includes a charge plan managed in the charge plan management table (Table 5), and payment information for purchasing the sheets corresponding to the number of printable sheets. In step S511, the print service 104 transmits a payment request of a money amount of the charge plan and the payment information to the data transmission/receiving unit 334 of the payment service 105. If the payment service 105 receives the payment request and the payment information, the payment processing unit 333 performs payment to a print service operator and charging processing to the user in accordance with the payment request. In the payment processing in step S511, payment information is transmitted from the print service 104 to the payment service 105.

By the print service 104 performing redirecting to the payment service 105, payment information may be transmitted from the client terminal 103 to the payment service 105. The above-described processing in step S511 is merely an example, and in a case where a third-party service provided by a payment business operator such as a credit-card company or a paying agent company is used as the payment service 105, processing suitable for the third-party service is performed. In step S512, the print service 104 transmits an increase instruction to increase the number of printable sheets of the charge plan to the data transmission/receiving unit 301. In step S513, the number-of-printable-sheets management unit 303 increases the number of printable sheets managed in the number-of-printable-sheets management table (the image forming apparatus 102) (Table 1) by the number of printable sheets in the increase instruction. In step S514, the image forming apparatus 102 returns a result indicating an increase success of the number of printable sheets. In step S515, the number-of-printable-sheets management unit 324 increases the number of printable sheets managed in the number-of-printable-sheets management table (the print service 104) (Table 4) by the number of printable sheets in the increase instruction. In step S516, the print service 104 returns a result indicating an increase success of the number of printable sheets.

Next, in the processing of steps S517 to S529, the user A performs copy and push notification and the processing of steps S517 to S529 is repeatedly executed asynchronously with the above-described steps S510 to S516. The processing in steps S517 to S529 may be executed after the processing in steps S510 to S516 is executed only once. The processing in steps S517 to S529 may also be executed after the processing in steps S510 to S516 is executed a plurality of times. The processing in steps S517 to S529 may be executed only once or may be executed a plurality of times. In the present embodiment, the processing in step S517 is described as copying, but may be printing or FAX printing.

In step S517, if the user A inputs a copy instruction to the user interface unit 306, the scan control unit 305 of the image forming apparatus 102 scans a document, and the print control unit 304 executes copying of the scanned document. In step S518, the number-of-printable-sheets management unit 303 reduces the number of printable sheets managed in the number-of-printable-sheets management table (the image forming apparatus 102) (Table 1), by the number of copied sheets. In step S519, the image forming apparatus 102 transmits a print result being a copy result obtained in step S517 to the data transmission/receiving unit 326. The print result includes a device ID, the number of printed sheets, printing date and time, the number of printable sheets after reduction in step S518, and the like. The print result may be transmitted each time a print result of one sheet or one print job is obtained, print results of a plurality of sheets, a plurality of print jobs, or in a fixed period may be collectively transmitted. In response to successful transmission of the print result in step 519, the print service 104 transmits, to the image forming apparatus 102, a response indicating the success of the transmission in step S520. In step S521, the number-of-printable-sheets management unit 324 updates the number of printable sheets with a device ID included in the print result that is managed in the number-of-printable-sheets management table (the print service 104) (Table 4), with the number of printable sheets included in the print result.

In step S522, the number-of-printable-sheets management unit 303 of the image forming apparatus 102 determines whether to execute notification. The processing in step S522 may be performed by the number-of-printable-sheets management unit 324 of the print service 104. In a case where the print service 104 performs the processing in step S522, the processing in steps S523 and S524 are omitted. Specific processing in step S522 will be described with reference to the flowchart in FIG. 6. The processing in step S518 and the processing in step S522 may be performed in a sequence order, or in a reverse order, or may be asynchronously performed in random order.

Turning to FIG. 6, in step S601 (S518), the number-of-printable-sheets management unit 303 performs processing of reducing the current number of printable sheets by the number of sheets on which printing has been executed in the number-of-printable-sheets management table (the image forming apparatus 102) indicated in Table 1. In step S602, in a case where the reduced number of printable sheets in the number-of-printable-sheets management table (the image forming apparatus 102) (Table 1) becomes less than or equal to a notification threshold value, in step S603 (S523), the number-of-printable-sheets management unit 303 issues a notification instruction. In a case where the reduced number of printable sheets is greater than the notification threshold value, the processing ends without issuing a notification instruction.

Returning to FIG. 5, in a case where the number-of-printable-sheets management unit 324 of the print service 104 performs the processing in the flowchart of FIG. 5, the number-of-printable-sheets management unit 324 performs reduction processing. Specifically, after the processing in S517, information regarding the number of printed sheets as print results is transmitted from the image forming apparatus 102 to the print service 104. Then, in step S521, the number-of-printable-sheets management unit 323 of the print service 104 updates the number-of-printable-sheets management table (the print service 104) indicated in Table 4. Specifically, the number-of-printable-sheets management unit 303 performs processing of reducing the current number of printable sheets by the number of sheets on which printing has been performed. In a case where it is determined in step S602 that the number of printable sheets after reduction in the number-of-printable-sheets management table (the print service 104) (Table 4) becomes less than or equal to the notification threshold value (YES in step S602), the processing proceeds to step S603. In step S603 (In step S523), the number-of-printable-sheets management unit 324 issues a notification instruction. In a case where the number of printable sheets after reduction is not less than or equal to the notification threshold value (NO in step S602), the processing ends without issuing a notification instruction. The threshold value may be a value equal to or greater than 1 or may be 0. That is, a notification instruction may be issued when the number of printable sheets gets low or when the number of printable sheets becomes zero.

In step S523, the image forming apparatus 102 transmits a push notification instruction to the data transmission/receiving unit 326 of the print service 104. The push notification instruction includes a device ID and the like. In step S524, the print service 104 returns reception completion to the data transmission/receiving unit 301. As described above, in the present embodiment, the image forming apparatus 102 performs notification determination processing. The print service 104 may perform notification determination processing based on the number of printable sheets and a notification threshold value in the number-of-printable-sheets management table (the print service 104) (Table 4). This notification performance is applicable to all subsequent embodiments.

In step S525, the print service 104 transmits the push notification instruction to the data transmission/receiving unit 344 of the push notification service 106. From the device management table (Table 3), it is possible to acquire information indicating that a user using the device A is the user A. From the user management table (Table 2), it is possible to acquire information indicating that a notification ID of the user A is 1111. The push notification instruction includes the notification ID, notification source information and a message to be displayed by the notification, a link to a charge UI, and the like, and the message is displayed in the messages 406 and 417. In step S526, the push notification service 106 returns reception completion to the data transmission/receiving unit 326. In step S527, the push notification processing unit 343 transmits a push notification instruction to the data transmission/receiving unit 311 of the client terminal 103 that corresponds to the notification ID included in the push notification instruction received in step S522. The push notification instruction includes notification source information, the message, a link to a charge UI, and the like. In step S528, the client terminal 103 returns reception completion to the data transmission/receiving unit 344. In step S529, the push notification control unit 316 displays the push notification 402 or 412 including notification source information, the message, the link to a charge UI, and the like that are included in the push notification instruction received in step S527. Then, if the user A selects a push notification via the user interface unit 314, it is possible to directly transition to a charge UI from the link to the charge UI that is embedded in the push notification. In a case where the link is a deep link to a charge UI of an application, a screen transitions to the UI as illustrated in FIG. 4C. In a case where the link is a link to a charge UI of a web site, a screen transitions to the UI as illustrated in FIG. 4D. The processing related to the push notification service 106 in steps S505 to S509 and steps S525 to S529 is merely an example. In a case where a push notification service provided by a third party is used, processing suitable for the service is performed.

As described above, in the present embodiment, a method of issuing a push notification to a terminal of a user in a case where the number of printable sheets becomes less than or equal to a threshold value has been described. With this method, even in a case where the user does not open an application or a web site of the print service, it is possible to make a notification to the user. The user can access a charge UI of the application or the web site of the print service from the push notification and can add money without issues.

The application or the web site of the print service 104 may be configured to issue a print instruction.

When performing copying, the user issues a copy instruction by operating a hardware key or an operation panel of an image forming apparatus. This operation is not considered to be one where the user issues an instruction from the application or the web site of the print service 104. Thus, if the number of printable sheets becomes insufficient during copying, the user can encounter an issue of having to search for a target application or a target web site from a menu screen of a client terminal. According to the present disclosure, by selecting a push notification displayed on a client terminal, the user can open a target screen, which improves user convenience.

### Second Embodiment

In the above-described first embodiment, a method of issuing a push notification to a terminal of a user in a case where the number of printable sheets becomes less than or equal to a threshold value has been described. A second embodiment will describe a method of issuing an email instead of a push notification.

In the first embodiment, a notification ID is managed in the user management table (Table 2) to issue a push notification. In the second embodiment, an email address is managed in place of a notification ID to issue an email notification.

Table 6 provided below indicates an example of user data to be managed by a user management unit 322 according to the present embodiment.

TABLE 6
User Management Table

| User | | Login | Login Expiration | Email | Delivery |
|---|---|---|---|---|---|
| ID | Password | state | Date | Address | Permission |
| user A | ********** | on | 2024 Dec. 31 0:00 | a@mail.com | true |
| user B | ********** | on | 2024 Dec. 31 0:00 | b@mail.com | true |
| user C | ********** | off | | c@mail.com, | true |
| | | | | d@mail.com | |
| user D | ********** | off | | | false |

A user ID column, a password column, a login state column, and a login expiration date column are the same as those described in Table 2. An email address column indicates an email address of a user to be designated as a transmission destination of an email notification. A delivery permission column indicates the setting of delivery permission provided by each user, where true indicates a setting in which delivery is permitted and false indicates a setting in which delivery is not permitted.

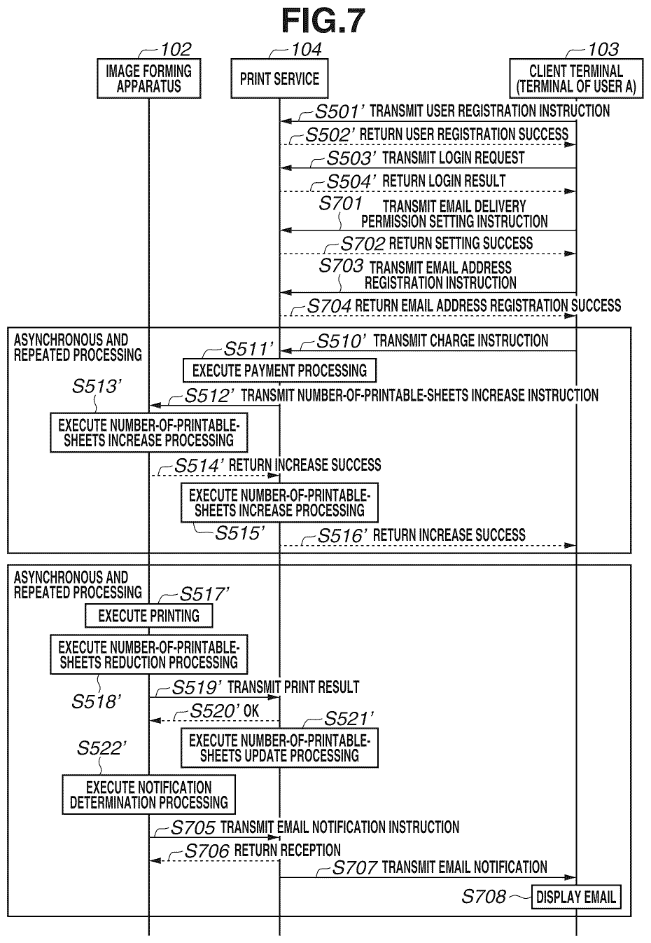

The overall processing sequence according to the present embodiment will be described with reference to FIG. 7. The processing in steps S501′ to S504′ and steps S510′ to S522′ is the same as the processing described in steps S501 to S504 and steps S510 to S522 of FIGS. 5A and 5B.

After the user A has performed login processing in steps S503′ and S504′, in step S701, the user A issues an email delivery permission instruction to the print service 104. The data transmission/receiving unit 311 of the client terminal 103 of the user A transmits the email delivery permission setting instruction input via the user interface unit 314, to the data transmission/receiving unit 326. In step S702, the user management unit 322 stores the received delivery permission setting into the user management table (Table 6) stored in the data storage unit 321, and returns a result indicating an email delivery permission setting success. In step S703, the user A performs the registration of an email address being an email notification destination into the print service 104. The data transmission/receiving unit 311 of the client terminal 103 of the user A transmits an email address and a registration instruction input via the user interface unit 314, to the data transmission/receiving unit 326. In step S704, the user management unit 322 stores the received email address into the user management table (Table 6) stored in the data storage unit 321, and returns a result indicating an email address registration success. In the present embodiment, an email delivery permission setting instruction and an email address registration instruction are issued as separate processes, but may be issued in the same processing. Email address registration may be executed in the same processing as the user registration instruction in step S501′.

In the case of issuing a notification instruction in step S522′, in step S705, the image forming apparatus 102 transmits an email notification instruction to the data transmission/receiving unit 326 of the print service 104. The email notification instruction includes a device ID and the like. In step S706, the print service 104 returns reception completion to the data transmission/receiving unit 301. In the present embodiment, the image forming apparatus 102 performs notification determination processing, but the print service 104 may perform notification determination processing.

In step S707, the print service 104 transmits an email notification to the client terminal 103. The data transmission in step S707 is performed by email transmission executed via a simple mail transfer protocol (SMTP) server. From the device management table (Table 3), it is possible to acquire information indicating that a user using the device A is the user A. From the user management table (Table 6), it is possible to acquire information indicating that an email address of the user A is “a@mail.com”. Thus, an email transmission destination can be determined. In addition, a title of a notification is set as a subject of the email. A notification message, a link to a charge UI, and the like are set as a body text of the email. In step S708, an email application or the like of the client terminal 103 displays the email received in step S707. Then, if the user A selects the link described in the email body text via the user interface unit 314, it is possible to directly transition to the charge UI. In a case where the link is a deep link to a charge UI of an application, a screen transitions to the UI illustrated in FIG. 4C. In a case where the link is a link to a charge UI of a web site, a screen transitions to the UI illustrated in FIG. 4D.

A configuration of displaying a push notification if an identifier of an application being a push notification destination is managed in the user management unit 322 and displaying an email notification if an email address is managed in the user management unit 322 may be employed. For example, a client terminal may not support a push notification in some cases. In these cases, the user registering an email address in the print service enables a notification to be issued via email.

As described above, in the present embodiment, a method of issuing an email notification to a terminal of a user in a case where the number of printable sheets becomes less than or equal to a threshold value has been described. This method enables, even in a case where the user does not open an application or a web site of the print service, to make a notification to the user. The user can access a charge UI of the application or the web site of the print service from an email, and can add money without any undue burden.

### Third Embodiment

In the first embodiment, a method of issuing a push notification to a terminal of a user in a case where the number of printable sheets becomes less than or equal to a threshold value has been described. The user might fail to notice the push notification in a case where the user is operating an image forming apparatus and a terminal is not located nearby, or the like. In a third embodiment, a method of displaying on an image forming apparatus, when issuing a push notification where the number of printable sheets becomes less than or equal to a threshold value, a message indicating that a push notification has been made will be described.

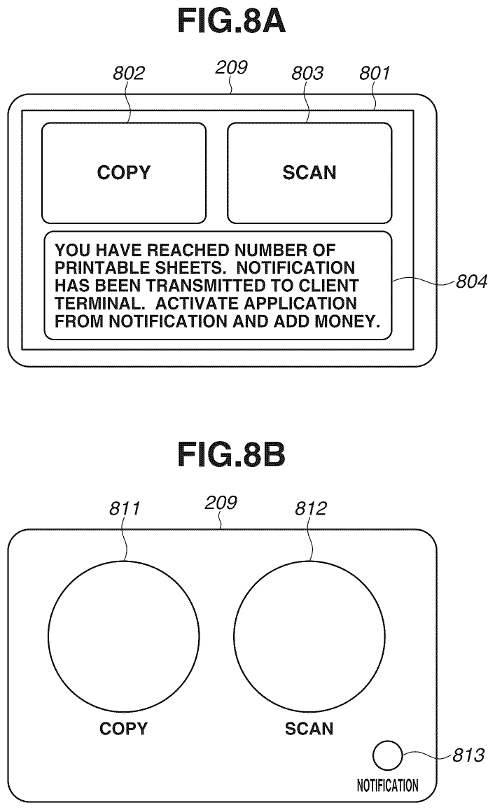

FIGS. 8A and 8B each illustrate a UI example of the operation panel 209 of the image forming apparatus 102 according to the third embodiment. FIG. 8A illustrates a UI example to be displayed in a case where the operation panel 209 is a touch panel operable by touching a liquid crystal panel. FIG. 8B illustrates a UI example to be displayed in a case where a liquid crystal panel is not provided in the operation panel 209.

FIG. 8A will now be described.

A liquid crystal panel 801 in FIG. 8A is a liquid crystal panel of the operation panel 209 of the image forming apparatus 102 used by the user A, where the liquid crystal panel is a touch panel operable by touch. A copy button 802 is a copy button for performing copying, and is displayed on the liquid crystal panel. The user can execute copying by touching the copy button 802. A scan button 803 is a scan button for performing scanning, and is displayed on the liquid crystal panel. The user can execute scanning by touching the scan button 803. In another embodiment, the buttons 802 and 803 may be physical buttons like physical buttons 811 and 812 described below. A message display area 804 is a message display area where a message indicating that the number of printable sheets has become less than or equal to a threshold value and a push notification has been made is displayed. This message is merely an example, and any message conveying similar information is applicable.

FIG. 8B will now be described.

FIG. 8B illustrates a copy physical button 811 for performing copying. The user can execute copying by pressing the copy physical button 811. Characters “copy” described below the copy physical button 811 are printed directly on the operation panel 209. A button 812 is a scan physical button for performing scanning. The user can execute scanning by pressing the scan physical button 812. Characters “scan” described below the scan physical button 812 are printed directly on the operation panel 209. A lamp 813 is an LED lamp or the like. In a case where a liquid crystal panel is not provided, the state of the image forming apparatus 102 is indicated by lighting the lamp 813. Characters “notification” described below the lamp 813 are printed directly on the operation panel 209. By presenting correspondence between a lighting pattern of the lamp 813 and the state of the image forming apparatus 102 to the user by a manual or the like, the user can recognize the state of the image forming apparatus 102 based on the lighting of the lamp 813. In the present embodiment, lighting the lamp 813 in a specific pattern when making a push notification makes, it possible to notify the user that a push notification has been made.

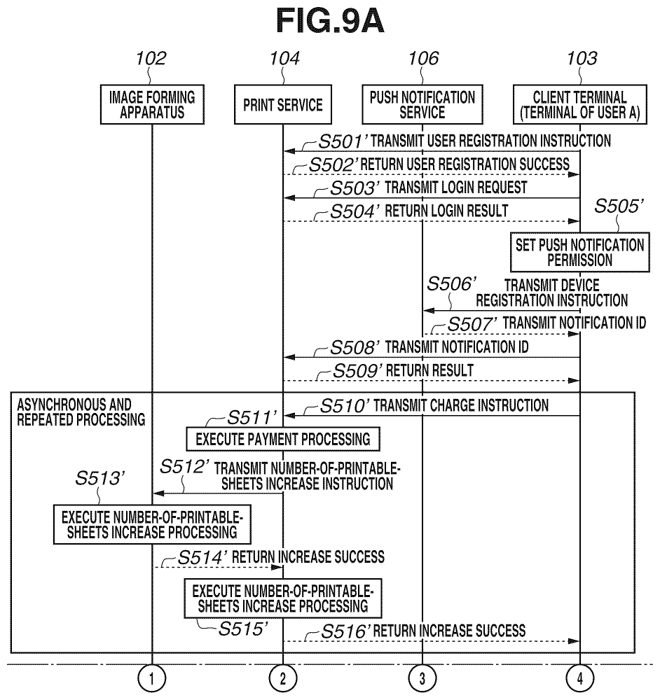

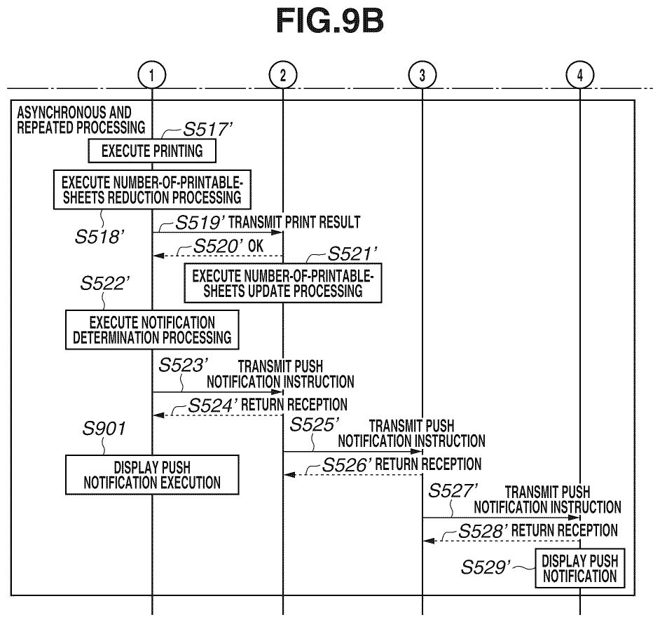

The overall processing sequence according to the present embodiment will be described with reference to FIGS. 9A and 9B. The processing in steps S501′ to S529′ is the same as the processing described in steps S501 to S529 of FIGS. 5A and 5B.

In step S524′, reception completion of a push notification instruction in step S523′ is returned to the image forming apparatus 102 from the print service 104, and then in step S901, the image forming apparatus 102 displays the execution of the push notification on the operation panel 209. In a case where the operation panel 209 includes a liquid crystal panel, message display in the message display area 804 in FIG. 8A is performed. In a case where the operation panel 209 does not include a liquid crystal panel, the lamp 813 in FIG. 8B is lit. When the print service 104 is configured to perform the processing in step S522′, in a case where it is determined that a notification instruction is to be issued, the print service 104 transmits an instruction to display push notification execution on the image forming apparatus 102 in addition to the processing in step S525′.

As described above, in the present embodiment, a method of displaying the execution of push notification on an image forming apparatus when the number of printable sheets becomes less than or equal to a threshold value and a push notification is issued has been described. This method enables, even in a case where the user is operating an image forming apparatus and a terminal is not present nearby, or the like, the user to notice the execution of the push notification.

### Fourth Embodiment

In the first embodiment, a method of issuing a push notification to a terminal of a user in a case where the number of printable sheets becomes less than or equal to a threshold value has been described. If a push notification is issued each time the number of printable sheets becomes less than or equal to a threshold value, a push notification is received even at a timing undesired by the user, which may become burdensome. In view of the foregoing, in a fourth embodiment, a method of providing a notification button on the image forming apparatus 102 and issuing a push notification in a case where the user presses the notification button will be described.

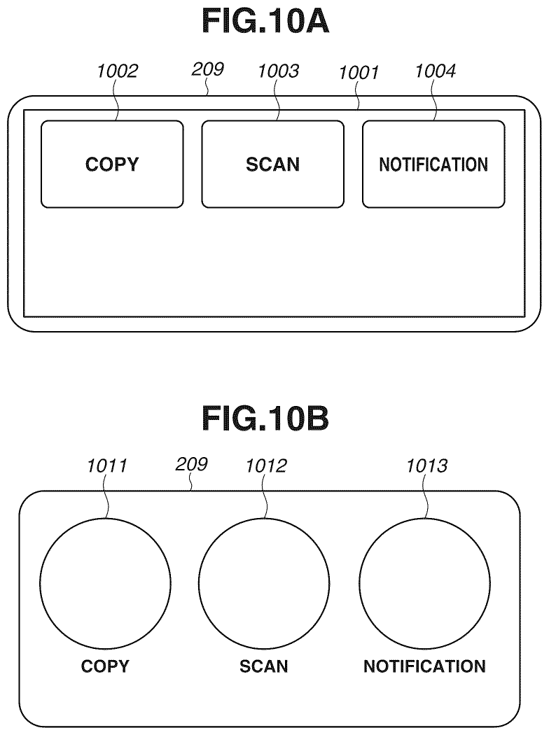

FIGS. 10A and 10B each illustrate a UI example of the operation panel 209 of the image forming apparatus 102 according to the fourth embodiment. FIG. 10A illustrates a UI example to be displayed in a case where the operation panel 209 is a touch panel operable by touching a liquid crystal panel. FIG. 10B illustrates a UI example to be displayed in a case where a liquid crystal panel is not provided in the operation panel 209.

FIG. 10A will now be described.

A liquid crystal panel 1001 in FIG. 10A is a liquid crystal panel of the operation panel 209 of the image forming apparatus 102 used by the user A, where the liquid crystal panel is a touch panel operable by touch. A button 1002 is a copy button for performing copying and is displayed on the liquid crystal panel. The user can execute copying by touching the copy button 1002. A button 1003 is a scan button for performing scanning and is displayed on the liquid crystal panel. The user can execute scanning by touching the scan button 1003. A button 1004 is a notification button for issuing a push notification and is displayed on the liquid crystal panel. The user can issue a push notification by touching the notification button 1004.

FIG. 10B will now be described.

A button 1011 in FIG. 10B is a copy physical button for performing copying. The user can execute copying by pressing the copy physical button 1011. Characters “copy” described below the copy physical button 1011 are printed directly on the operation panel 209. A button 1012 is a scan physical button for performing scanning. The user can execute scanning by pressing the scan physical button 1012. Characters “scan” described below the scan physical button 1012 are printed directly on the operation panel 209. A notification physical button 1013 is a notification physical button for issuing a push notification. The user can issue a push notification by pressing the notification physical button 1013. Characters “notification” described below the notification physical button 1013 are printed directly on the operation panel 209.

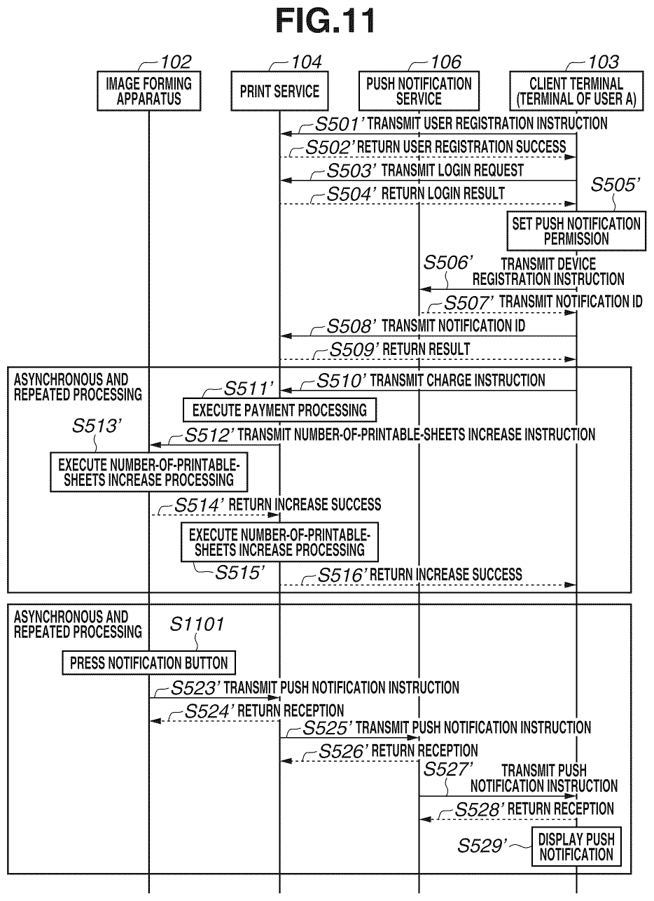

The overall processing sequence according to the present embodiment will be described with reference to FIG. 11. The processing in steps S501′ to S516′ and steps S523′ to S529′ is the same as the processing described in steps S501 to S516 and steps S523 to S529 of FIGS. 5A and 5B.

In step S1101, if the user A touches the notification button 1004 or presses the notification physical button 1013, a push notification instruction is input to the user interface unit 306. If the push notification instruction is input, in step S523′, the image forming apparatus 102 transmits a push notification instruction to the data transmission/receiving unit 326 of the print service 104.

The push notification instruction may be transmitted whenever the push notification instruction is input, or may be transmitted only in a case where the number of printable sheets in the number-of-printable-sheets management table (the image forming apparatus 102) (Table 1) is less than or equal to a notification threshold value.

As described above, in the present embodiment, a method of preparing a notification button on the image forming apparatus 102 and issuing a push notification in a case where the user presses the notification button has been described. This method makes it possible to issue a push notification at a timing desired by the user.

### Other Embodiments

The present disclosure can also be implemented by a process of supplying a program implementing one or more functions of each of the above-described embodiments to a system or an apparatus via a network or a storage medium, and one or more processors in a computer of the system or the apparatus reading out and executing the program. The present disclosure can also be implemented by circuitry implementing one or more of the above-described functions (for example, application specific integrated circuit (ASIC) or a field programmable gate array (FPGA)).

According to above-described embodiments of the present disclosure, it is possible to provide a structure of enabling the user to browse a screen so the user can easily purchase additional number of sheets to be printed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-176788, filed Oct. 8, 2024, which is hereby incorporated by reference herein in its entirety.

What is claimed is:

1. A system comprising:
an image forming apparatus;
a server configured to manage a number of sheets permitted to be used by the image forming apparatus for printing operations; and
a client terminal,
wherein the image forming apparatus transmits, to the server, information indicating a number of sheets used for a printing operation by the image forming apparatus,
wherein the server receives an instruction, from a user via a screen displayed on the client terminal, to increase the number of sheets permitted to be used by the image forming apparatus,
wherein, based on the received instruction, the server manages the number of sheets permitted to be used by the image forming apparatus,
wherein, in a case where the number of sheets permitted to be used by the image forming apparatus is less than a number of sheets required to execute a printing operation, the server transmits information for issuing a push notification on the client terminal to a different server, and
wherein, if the push notification is selected by a user on the client terminal, the screen is displayed.

2. An image forming apparatus that can communicate with a server configured to manage a number of sheets permitted to be used by the image forming apparatus for printing operations, the image forming apparatus comprising:
at least one memory storing a program; and
at least one processor, that when executing the program, is caused to:
transmit, to the server, information indicating a number of sheets used for a printing operation by the image forming apparatus,
wherein, in a case where the number of sheets permitted to be used by the image forming apparatus is less than a number of sheets required to execute a printing operation, information for issuing a push notification on a client terminal of a user of the image forming apparatus is transmitted from the server to a different server, and
wherein, if the push notification is selected by a user on the client terminal, a predetermined screen is displayed.

3. The image forming apparatus according to claim 2, wherein the at least one processor is further caused to:
manage the number of sheets permitted to be used by the image forming apparatus for printing operations;
determine whether the number of sheets permitted to be used by the image forming apparatus is less than the number of sheets required to execute a printing operation; and
issue a notification to the server in a case where it is determined that the number of sheets permitted to be used by the image forming apparatus is less than the number of sheets required to execute a printing operation.

4. The image forming apparatus according to claim 2, wherein the at least one processor is further caused to:
issue a notification indicating that the push notification has been transmitted to the client terminal in a case where the number of sheets permitted to be used by the image forming apparatus is less than the number of sheets required to execute a printing operation.

5. The image forming apparatus according to claim 4, wherein the at least one processor is further caused to:
display, as the notification, a message indicating that the push notification has been transmitted to the client terminal, on a display of the image forming apparatus.

6. The image forming apparatus according to claim 4, wherein the at least one processor is further caused to:
light a lamp of the image forming apparatus in a specific pattern, as the notification indicating that the push notification has been transmitted to the client terminal.

7. The image forming apparatus according to claim 2, the image forming apparatus further comprising a predetermined button and the at least one processor is further caused to:
issue a notification to the server,
wherein, if the notification is issued to the server, the information for issuing the push notification on the client terminal of a user of the image forming apparatus is transmitted from the server to the different server.

8. The image forming apparatus according to claim 2,
wherein the at least one processor is further caused to:
manage the number of sheets permitted to be used by the image forming apparatus for printing operations, and
wherein the managed number of sheets permitted to be used by the image forming apparatus for printing operations is changeable based on receipt of an instruction.

9. A method of an image forming apparatus that can communicate with a server configured to manage a number of sheets permitted to be used by the image forming apparatus for printing operations, the method comprising:
transmitting, to the server, information indicating a number of sheets used for a printing operation by the image forming apparatus,
wherein, in a case where the number of sheets permitted to be used by the image forming apparatus is less than a number of sheets required to execute a printing operation, information for issuing a push notification on a client terminal of a user of the image forming apparatus is transmitted from the server to a different server, and
wherein, if the push notification is selected by a user on the client terminal, a predetermined screen is displayed.

10. A storage medium storing a program for executing a method of an image forming apparatus that can communicate with a server configured to manage a number of sheets permitted to be used by the image forming apparatus for printing operations, the method comprising:
transmitting, to the server, information indicating a number of sheets used for a printing operation by the image forming apparatus,
wherein, in a case where the number of sheets permitted to be used by the image forming apparatus is less than a number of sheets required to execute a printing operation, information for issuing a push notification on a client terminal of a user of the image forming apparatus is transmitted from the server to a different server, and
wherein, if the push notification is selected by a user on the client terminal, a predetermined screen is displayed.
